(19) United States
(12) Patent Application Publication
(10) Pub. No.: US 2006/0132264 A1
(43) Pub. Date: Jun. 22, 2006

(54) Temperature compensation of resonators using different materials for housing and inner conductor as well as suitable dimensions

(75) Inventors: Michael Hoft, Seevetao (DE); Johannes Muller, Hamburg (DE)

Correspondence Address: NIXON & VANDERHYE, PC, 901 NORTH GLEBE ROAD, 11TH FLOOR, ARLINGTON, VA, 22203, US

(73) Assignee: Matsushita Electric Industrial Co., Ltd., Kadoma City (JP)

(21) Appl. No.: 11/305,039

(22) Filed: Dec. 19, 2005

(30) Foreign Application Priority Data
Dec. 21, 2004 (EP) 04030265.5

(51) Int. Cl. H01P 7/06

(52) U.S. Cl. 333/227

(57) ABSTRACT

The present invention relates to a method for determine values for a set of construction parameters of a cavity resonator (1) comprising a housing (2) having a base (3), a sidewall (4) extending upwardly from the base (3) and an upper cover plate (5), and an inner conductor (6) having a width dimension D and extending upwardly from the base (3) along a length L, the housing (2) comprising a first material and the inner conductor (6) comprising a second material different from the first material. These values yield a minimum temperature induced change of resonant frequency f₀ in a given temperature range ΔT with respect to the set of construction parameters. To determine the values, the resonant frequency f₀ is calculated as a function of temperature and the set of construction parameters. The values of the set of construction parameters are varied, and the calculating step is repeated to derive optimum values for the set of construction parameters from the result of the calculation yielding a minimum temperature induced change of resonant frequency f0 in a given temperature range ΔT with respect to the set of construction parameters. The set of construction parameters includes the width dimension D of the inner conductor (6).

The present invention relates to a method of determining values for a set of construction parameters of a temperature compensated cavity resonator.

Cavity resonators essentially comprise a space contained within a closed or substantially closed conducting surface. Due to their ability to maintain, upon suitable external excitation, an oscillating electromagnetic field within this space and their display of marked resonance effects at distinct resonant frequencies f₀, thereby giving maximum response over a narrow band of frequencies while rejecting frequencies outside that band, they are of great interest in various fields of technology. This is particularly true for high frequency applications utilizing frequencies for which the skin effect would make the resistance of standard tuned circuits too high and for which their open construction would cause them to act as antennas resulting in excessive radiation loss. Accordingly, cavity resonators find widespread application for receiving, generating, amplifying, processing and/or transmitting electromagnetic signals having frequencies e.g. in the radio or microwave regions of the electromagnetic spectrum.

As an example, cavity resonators are regularly utilized in wireless communication systems, such as mobile communication or satellite communication systems, which often operate in the microwave region. In these applications, cavity resonators are typically used as filters or parts of filter structures for transmitting and receiving electromagnetic waves in selected frequency bands. In order to form microwave components, such as band-pass filters, a plurality of cavity resonators may be coupled together in series and/or in parallel in various configurations.

In these as well as in other applications, it is essential for the cavity resonators to have a predetermined resonant frequency. As the resonant frequency is determined by the size and shape of the resonator structure, the dimensions of a particular cavity resonator have to be thoroughly calculated and the production process has to be carefully controlled. Some cavity resonators are designed to be adjustable with regard to their resonant frequency. This can e.g. be accomplished using one or more tuning screws for each cavity that move small pieces of metal or a dielectric material into or out of the cavity.

Furthermore, it is generally of great importance for the cavity resonators of a device to be stable over a wide range of working temperatures. For microwave filters, temperature stability has the advantage that the filters band pass requirements can be maintained over the whole range without using additional bandwidth. Eventually one can design the filter with a larger bandwidth without violating the band stop requirements, which decreases the insertion loss.

However, any kind of resonator structure is subject to thermal expansion and contraction of its housing and other components such as e.g. inner conductors, which potentially lead to a change in resonant frequency as the temperature varies. Consequently, such systems have to be stabilized with respect to temperature and/or they may require regular re-adjustment, both of which results in high costs. Moreover, the minimum practical bandwidth of a cavity resonator device, such as a microwave filter, becomes a function of the operating temperature range. Generally, the amount of expansion and contraction of a dimension depends on its size, the change in temperature and the coefficient of thermal expansion (CTE) of the material and is described by the following equation:
Δƒ=(1+α.ΔT).ƒ,
where α is the CTE of the material, ΔT the change in temperature and 1 the length of the dimension.

It has been shown that any resonator structure built out of only one material undergoes a shift in resonant frequency described by the following equation:

$$f ( Δ T ) = {f}_{0} \frac{1}{( 1 + α \cdot Δ T )} .$$

Accordingly, a resonator structure made of aluminium (CTE˜23.8×10⁻⁶) undergoes a shift in resonant frequency of around 23.8 ppm which corresponds to 47.6 kHz/K for a 2 GHz resonator.

One particular type of cavity resonator regularly used to build e.g. microwave filters is known as combline resonator. This resonator structure comprises a coaxial resonator shortcircuited at one end and open circuited at the other end, i.e. a housing defining a cavity and having a longitudinal axis, and a coaxial inner conductor electrically connected to the housing at only one end. In a certain distance above the open end of the inner conductor, the housing is enclosed by a cover so that a gap exists between one end of the inner conductor and the inner surface of the cover. Essentially, such a combline resonator can be regarded as a section of coaxial transmission line that is short-circuited at one end and capacitatively loaded (open) at the other end. Microwave energy may be coupled into the cavity by a magnetic loop antenna located near the inner conductor at the short-circuited end of the transmission line. The free space between the top of the inner conductor and the cover is referred to as the capacitive gap. In the state of the art, setting the resonant frequency of a combline resonator has been accomplished by determining suitable values for the length of the cavity, the length of the inner conductor and the size of the capacitive gap.

To render a combline resonator adjustable, a hole may be provided in the cover above the inner conductor, in which hole a tuning screw is placed. Adjusting the tuning screw one can change the capacitive gap and thus control the resonant frequency. In some cases, the inner conductor may be provided as a partly hollow component and the tuning screw may be arranged to at least partly penetrate this inner conductor. Such a resonator structure is referred to as re-entrant combline resonator. The tuning screw may also be disposed in holes provided in the sidewalls or the base of the housing.

Various techniques have been proposed to achieve temperature compensation of combline cavity resonators.

According to one approach, combline resonators have regularly been designed using Invar as the material for the housing and the inner conductor to limit the change of the length of the housing and of the inner conductor (see e.g. GB 2 305 547). Invar, an alloy of iron with 36% of nickel, has been chosen due to its very low CTE (˜2×10⁻⁶). However, Invar has an electrical conductivity which is too low for satisfactory use as the inner surface material of a cavity resonator. Therefore, when using Invar the inner surfaces have to be coated with a conductive material, e.g. silver or gold, which renders such resonators very expensive. Furthermore, Invar is relatively heavy.

A further known measure to improve the temperature stability characteristics of cavity resonators resides in decreasing the length of the resonator and of the inner conductor to reduce the absolute value of the change of the length dimensions (see e.g. GB 2 305 547). However, the resonator becomes very small resulting in a low energy storage capacity (quality factor) and in an increased danger of arcing due to the small size of the capacitive gap. Moreover, only slight improvements can be obtained.

WO 98/58419 discloses a combline resonator in which an additional metal-based plate assembly is arranged within the cavity on the underside of the cover of the housing. The plate assembly comprises a strip having a center portion located at a distance over the free end of the inner conductor. The dimensions and the CTE of the strip are chosen such that this distance changes upon change of temperature to compensate for the changes of the length of the housing and the inner conductor, thus achieving temperature compensation. This construction has the disadvantage that it is difficult to manufacture resulting in high costs. In addition, such a resonator is impractical in use and does not permit tuning.

The article “Design and Testing of SMA Temperature-Compensated Cavity Resonators”, IEEE MTT, vol. 51, Dec 2003, pp.2284-2289, by Brain F. Keats describes the use of spring-biased shape memory alloys (SMA) to form an actuator for controlling the length of tuning screws in order to compensate the temperature induced frequency drift due to a change of the length of the housing and of the inner conductor. These cavity resonators have the disadvantage of a very complex manufacturing process resulting in high costs.

In GB 2 305 547, it has been recognized that an increase in the length of the inner conductor tends to decrease the resonant frequency, whereas an increase in the size of the capacitive gap tends to increase the resonant frequency, and that it should in principle be possible to balance these effects in order to achieve temperature compensation by choosing different materials for the housing and the inner conductor. However, it is further described that it has been found that filters constructed accordingly nevertheless exhibit an unacceptable frequency drift. For this reason, GB 2 305 547 discloses a combline resonator with a composite inner conductor comprising two different materials. Such a construction can lead to an overall CTE of the inner conductor resulting in improved temperature compensation characteristics of the resonator. However, the frequency drift of such resonator is still considered to be too high for many applications.

The object of the present invention is to provide a method for determining a set of construction parameters for a combline resonator having improved temperature compensation characteristics.

This object is achieved by a method with the features of claim 1. Further preferred embodiments of the invention are the subject-matter of the dependent claims.

According to the present invention, values for a set of construction parameters of a combline resonator are determined, i.e. of a cavity resonator comprising a housing having a base, a sidewall extending upwardly from the base and an upper cover plate, and further comprising an inner conductor having a width dimension D (e.g. a diameter) and extending upwardly from the base along a length L. The method of the invention is applicable to combline resonators in which—at least in part —different materials are chosen for the housing and the inner conductor so that the housing comprises a first material and the inner conductor comprises a second material different from the first material. To determine the values, the resonant frequency f₀ is calculated as a function of temperature and the set of construction parameters. Further, the values of the set of construction parameters are varied and this calculating step is repeated to eventually derive from the result of the calculation specific values for the set of construction parameters, the specific values being optimum values in that they yield a minimum temperature induced change Δf₀ of resonant frequency f₀ in a given temperature range ΔT with respect to the set of construction parameters. The optimum values and the minimum temperature induced change Δf₀ may be an absolute minimum, a local minimum, or an absolute or local minimum under at least one boundary condition or constraint. According to the invention, the set of construction parameters includes the width dimension D of the inner conductor.

The method of the invention provides the advantage that it is not necessary to provide the cavity resonator with complex and/or expensive means to achieve temperature compensation. Rather, a temperature compensated combline resonator may be built in accordance with the basic construction principle of this type of resonator. In contrast to previously known temperature compensation techniques, the method of the present invention not only takes into account the length of the inner conductor, but also a width dimension such as its diameter. In the prior art, the width dimension(s) D of the inner conductor was (were) only considered with regard to achieving a high quality factor. The quality factor of a cavity resonator is a measure of how lossy the resonator is, i.e. a measure of the speed with which the stored energy is dissipated. It is generally defined as the ratio of the energy stored in the resonator to the energy dissipated per cycle of resonance, and upon stop of the excitation of the resonator, the amplitude of oscillation will decrease exponentially with a speed determined by the quality factor. As the quality factor depends on the ratio of the width dimension(s) D to the width dimension(s) A of the housing (e.g., for a cylindrical resonator and a cylindrical inner conductor the ratio of the diameters A/D=3.59 was found to be the optimum value for a high quality factor), the width dimension(s) D was (were) generally set to the appropriate value.

In a preferred embodiment, the set of construction parameters includes the length L of the inner conductor, the geometry of the inner conductor (preferably the cross-sectional geometry), the height or length H of the housing, the width dimension A of the housing and/or the geometry of the housing (preferably the cross-sectional geometry). It is further preferred if the set of construction parameters includes the first material and/or the second material, i.e. if the method determines suitable choices of material based on their physical properties having an influence on the resonant frequency, such as CTE, electrical conductivity and/or thermal conductivity.

The method of the present invention may further be advantageously applied to combline resonators having an inner conductor comprising at least two sections, each having a length Lᵢ, a width dimension Dᵢ and a geometry such as a cross-sectional geometry, and each comprising a material, i.e. if the width, the (cross-sectional) geometry and the material composition of the inner conductor varies along its length. With other words, if the inner conductor comprises n sections, the length and width of section j=1, 2, . . . , n is Lⱼ and Dⱼ, respectively. In this case, the set of construction parameters preferably includes the length Lᵢ of at least one of the sections of the inner conductor, the width dimension Dᵢ of at least one of the sections of the inner conductor, the geometry (preferably the cross-sectional geometry) of at least one of the sections of the inner conductor, and/or a material of at least one of the sections of the inner conductor. The section of the inner conductor which is located adjacent the base may also be formed integrally with the base. In case the geometry is a cross-sectional geometry, the sections may e.g. have circular, elliptical, square, hexagonal or rectangular cross-sections or may have any other cross-sectional geometry. Such inner conductors comprising a plurality of sections are advantageous because they provide more degrees of freedom for the optimization procedure. The transition from on section to the other may be gradual or continuous. For example, in case two sections of the inner conductor both consist of the same material and have diameters D₁ and D₂, a beveled, continuous transition between these sections is advantageous with respect to the quality factor, because the current can flow along a shorter path.

The method of the present invention may also advantageously be applied to combline resonators having an inner conductor formed by a composite element also comprising a third material different from the second material. In this case, the inner conductor can include a first portion comprising the second material and a second portion comprising the third material, wherein the second portion of the inner conductor may be formed integrally with the base or as a separate component. For any such resonator comprising a third material, it is preferred if the set of construction parameters includes the third material. Of course, such a composite inner conductor may also include more than two different materials, and each material may be included in the set of construction parameters.

The method of the present invention may also be advantageously applied if the housing comprises at least two sections, each having a height or length Hi, a width dimension Aᵢ and a geometry such as a cross-sectional geometry, and each comprising a material, i.e. if the width, the (cross-sectional) geometry and the material composition of the inner conductor varies along its length. In this case, the set of construction parameters preferably includes the length Lᵢ of at least one of the sections of the housing, the width dimension Aᵢ of at least one of the sections of the housing, the geometry (preferably the cross-sectional geometry) of at least one of the sections of the housing, and/or a material of at least one of the sections of the housing. In case the geometry is a cross-sectional geometry, the sections may e.g. have circular, elliptical, square, hexagonal or rectangular cross-sections or may have any other cross-sectional geometry. For a housing comprising a rectangular cross-section, the corners are commonly rounded due to the manufacturing process. For such a housing, the set of parameters could include the length and/or width of the rectangle of the cross-section, and could further include the radius of curvature of the rounded corners. The above housings comprising a plurality of sections are advantageous because they provide more degrees of freedom for the optimization procedure. Again, the transition from on section to the other may be gradual or continuous.

The method of the present invention may also be advantagously applied in the case that in at least a portion of the inner conductor and/or the housing a width dimension functionally depends on the height along the length of the inner conductor and the housing, respectively. It is then preferred that the set of construction parameters includes the functional dependence between the width dimension of the inner conductor and the height along the length of the inner conductor and/or the functional dependence between the width dimension of the housing and the height along the length of the inner conductor.

Accordingly, a large number of free parameters or degrees of freedom may be used to achieve a more stable temperature behavior of the resonant frequency. If possible, it is preferred to select the width dimension(s) of the lower section or the lower sections of the inner conductor such that the optimum value for the quality factor is obtained (e.g. A/D=3.59), and to use only the remaining parameters for the optimization procedure.

The transitions between the inner conductor and the base, and/or between the sidewall and the upper cover or the base may be rounded. Further, the upper end of the inner conductor may be rounded to prevent excessive electrical field strengths at the edges. However, in case such configurations are not too pronounced, they may be disregarded for the purpose of the optimization procedure.

In a preferred version of the method of the present invention the optimum values for the set of construction parameters are derived under at least one boundary condition or constraint. Such a boundary condition or constraint may be maximum and/or minimum values for the possible values of some or all of the parameters in the set of construction parameters. E.g., one possible boundary condition is that the width dimension of the inner conductor may not exceed the inner diameter of the housing. Further possible boundary conditions include a maximum value for the sensitivity of the optimum values against tolerances. In a preferred embodiment, the method comprises the step of calculating the quality factor as a function of temperature and the set of construction parameters, and to derive the optimum values for the set of construction parameters under the boundary condition that the quality factor is larger than a predetermined value. In this way, a situation can be taken into account in which a trade-off between the frequency drift and the quality factor of the cavity resonator is required.

It is preferred to use a mode matching method for the calculation of the resonant frequency. This method is particularly fast and precise for symmetrical structures, e.g. for a cylindrical housing and a cylindrical inner conductor.

The method of the present invention may further advantageously be applied to combline resonators comprising a tuning element which is partially inserted into an aperture of the cover plate and is selectively movable to protrude into the cavity in alignment with the inner conductor. It is also possible that the aperture for the tuning element is located in the sidewalls or the base of the housing. Such a tuning element may for example be constituted by one of the tuning screws described above. When a tuning element is provided, the set of construction parameters may include the material of the tuning element, the protrusion depth of the tuning element into the cavity and/or a width dimension or diameter of the tuning element. Further, the method of the present invention may advantageously be applied to a re-entrant combline resonator. In this case, the set of construction parameters may further include the geometry and/or depth of the recess in the inner conductor, and/or the penetration depth of the tuning element into the partly hollow inner conductor.

The method of the present invention may advantageously be applied to a combline resonator having a cylindrical inner conductor and/or a cylindrical housing.

The method of the present invention may further advantageously be applied to cavity resonator filters.

Once the optimum values for a set of construction parameters have been determined by the method of the invention, a temperature compensated cavity resonator may be produced by simply providing a housing in accordance with the determined values, by providing an inner conductor in accordance with the determined values, and by attaching the inner conductor to the housing.

In the following, the invention is explained in more detail for preferred embodiments with reference to the figures.

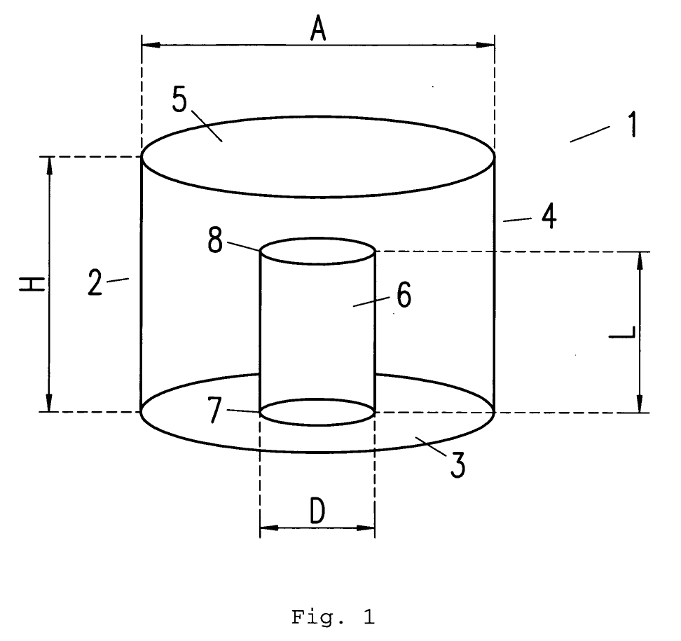

FIG. 1 is a schematic perspective view of a combline cavity resonator.

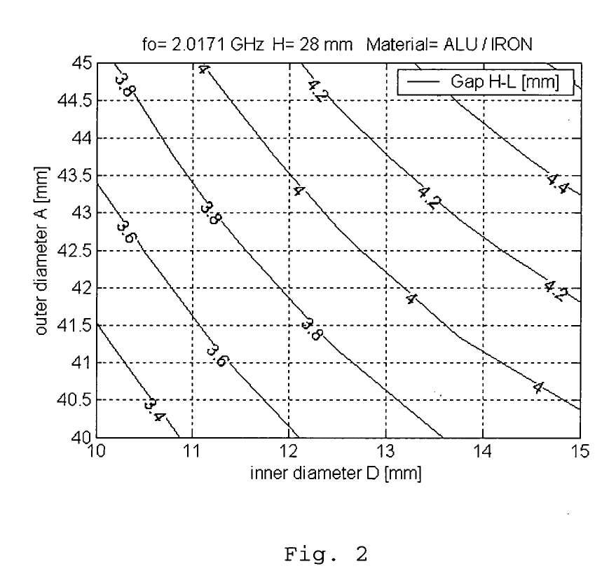

FIG. 2 is an exemplary contour plot showing the required capacitive gap in dependence of the diameter A of the housing and the diameter D of the inner conductor for achieving a resonant frequency of 2.0171 GHz for a particular resonator for −10° C. to 70° C.

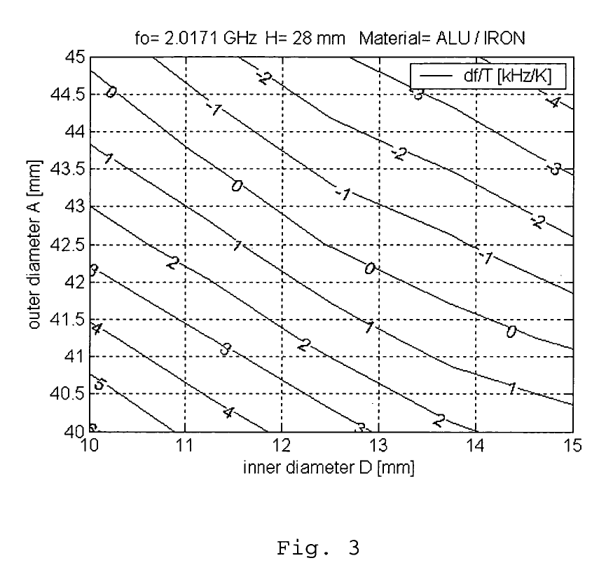

FIG. 3 is an exemplary contour plot showing the resulting temperature induced frequency drift in a temperature range of −10° C. to 70° C. in dependence of the diameter A of the housing and the diameter D of the inner conductor for a resonant frequency of 2.0171 GHz, and a particular resonator.

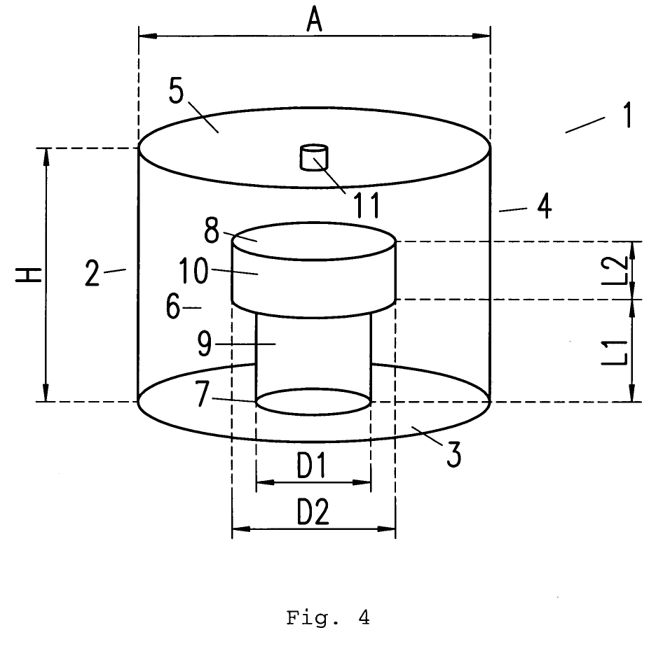

FIG. 4 is a schematic perspective view of a further combline cavity resonator comprising an inner conductor having two sections of different diameter.

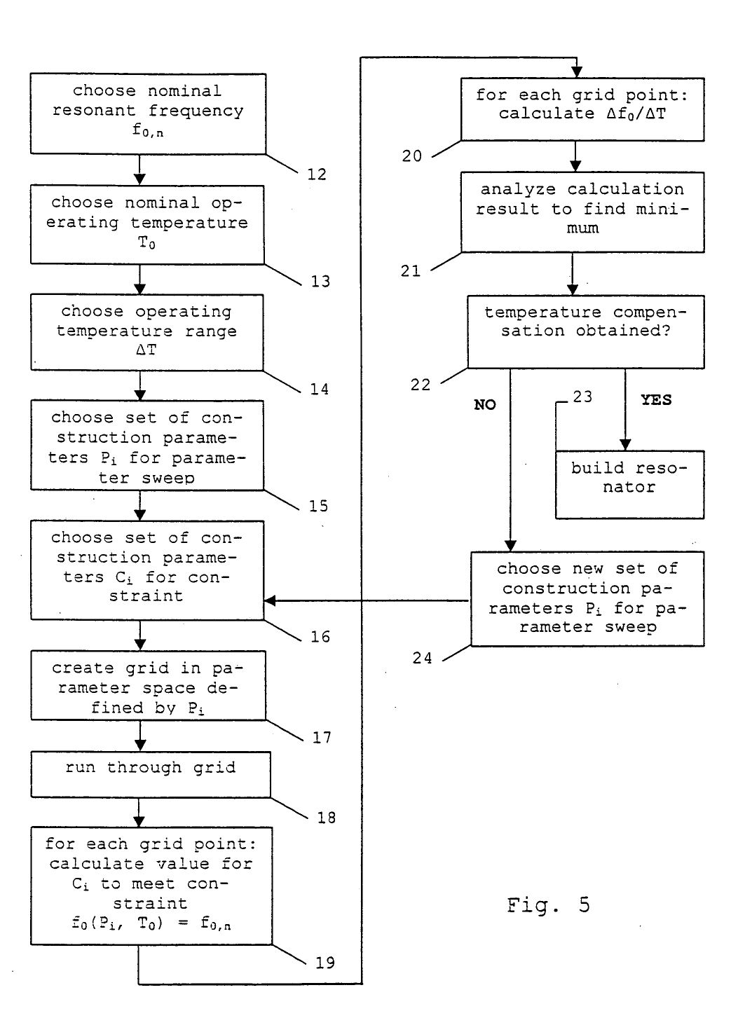

FIG. 5 is a schematic flowchart diagram illustrating a preferred embodiment of the method in accordance with the present invention.

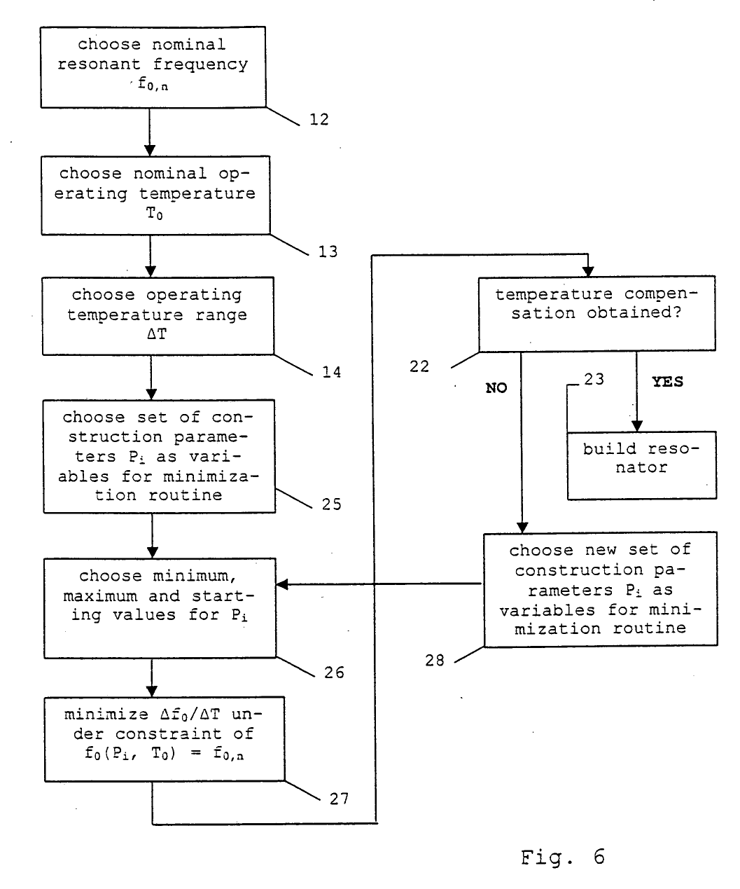

FIG. 6 is a schematic flowchart diagram illustrating a further preferred embodiment of the method in accordance with the present invention.

In FIG. 1, a cylindrical combline cavity resonator 1 is shown. The resonator 1 comprises a hollow cylindrical housing 2 having a length H and a diameter A. The housing 2 is constituted by disc shaped base 3, a wall 4 extending upwardly from the base 3, and a disc shaped cover 5 secured to the upper end of the wall 4. For reasons of weight and costs, the housing 2 is preferably composed of aluminum. However, it may also advantageously be composed of iron, copper, brass or Invar, or may be a composite component comprising two or more of these or other materials. Further advantageous choices of materials include PVC or ceramic materials. It is only important that the coefficient of thermal expansion is known and that the material is a good conductor or is plated with a good conducting material such as silver.

The resonator 1 further comprises a cylindrical inner conductor 6 centrally attached at its lower end 7 to the base 3 of the housing 2. The inner conductor 6 extends upwardly from the base 3 along the longitudinal axis of the cylindrical housing 2. The inner conductor has a length L and a diameter D. The length L is lower than the length H of the housing 2 so that a capacitive gap is formed between the upper end 8 of the inner conductor 6 and the cover 5 of the housing 2. The inner conductor 6 is preferably composed of iron, copper, brass or Invar, or is a composite component comprising two or more of these materials. However, further advantageous choices of materials are also possible such as PVC or a ceramic material. It is only important that the coefficient of thermal expansion is known and that the material is a good conductor or is plated with a good conducting material such as silver.

The field in the resonator 1 is excited by an external circuit (not shown) through suitable coupling means (not shown), which may e.g. comprise an aperture or a coupling loop and radiate a wave into the resonator cavity.

According to the invention, different materials are chosen for the housing 2 and the inner conductor 6, and the dimensions of the resonator, including the diameter D of the inner conductor 6, are chosen to achieve temperature compensation. A preferred version of the invention utilizes a mode matching method to accurately calculate the resonant frequency depending on all dimensions, namely the length H of the housing 2, the length L of the inner conductor 6, and the diameters D and A of the inner conductor 6 and the housing 2, respectively, as a function of temperature. While a standard finite element technique can also be used for this purpose, it is much more time consuming in order to converge as compared to a mode matching technique.

The mode matching method is based on the fact that in the resonator 1 the field can be expanded into a complete set of vector wave functions, which are usually referred to as modes. According to the mode matching technique, the total mode fields are matched at each junction between uniform sections. The amplitudes of the separate modes at the output of a junction can be deduced in terms of the amplitudes of the mode spectrum at the input to the junction. Knowing the mode spectrum one can calculate the wave-admittance of any mode in both directions of propagation. The wave-admittance at the junction is thus a function of all modes and its amplitudes. The total admittance of a mode is the sum of the wave admittances seen in both directions. In the present case, if the reference plane is the end of the inner conductor, the wave admittances are taken looking into the capacitative gap and looking into the short-circuited ground. The reference plane can be chosen arbitrarily over the whole inner conductor, but for faster calculation the junction is taken. Resonance occurs if the total admittance of the mode is zero.

As noted above, the calculation of the resonant frequency can also be accomplished by solving Maxwell's equations using finite element analysis. The necessary calculations may be performed using a variety of commercial software products allowing the determination of the modes of the resonators. Examples include HFSS by Ansoft or Microwave Studio by CST.

The above calculations may advantageously be performed by means of suitable computer programs deriving the full response of the cavity resonator.

FIGS. 2 and 3 show exemplary contour plots illustrating the result of a calculation for a resonator 1 wherein the set of construction parameters for which optimum values are calculated comprises the diameter A of the housing 2, the diameter D of the inner conductor 6 and the length L of the inner conductor 6. The housing 2 has a predetermined length H of 28 mm and is made of aluminum. The inner conductor 6 is made of iron, and the resonant frequency is 2.0171 GHz. From FIG. 2, the size of the capacitive gap and thus the length L of the inner conductor 6 can be derived, and from FIG. 3, optimum values for the diameters A and D of the housing 2 and the inner conductor 6, respectively, can be derived.

The structure of the resonator 1 is more simple than that of a re-entrant combline resonator that uses three different materials for compensation. If a tuning screw is provided in the resonator 1, it does not need to penetrate the inner conductor 6. Therefore, the size of the resonator 1 can be larger, leading to a better quality factor. Such a tuning screw would only function as a tuning element, which in the ideal case is planar to the lower surface of the cover 5 of the housing 2. Thus, the capacitive gap can be larger, which makes it more resistant against arcing in high electric fields. Furthermore, there are no sharp edges, like the edges from the re-entrant resonator structure, which potentially lead to arcing in high electrical fields and to surface currents that increase the losses.

According to the invention, the resonant frequency can automatically be calculated as a function of temperature, changing all parameters H, L, A, D depending on the respective CTE, size and temperature. Sweeping over all dimensions, one can easily and fast find suitable dimensions that result in compensated structures. While former research only incorporated the length of the resonator as well as the size of the capacitive gap, the present invention also sweeps over the radii to achieve temperature compensation. In doing so, depending on the requirements a trade-off between the resulting temperature induced change of resonant frequency, resonator size and quality factor might be required. For example, instead of a ratio A/D=3.59 in the case of a cylindrical resonator shape, which is the optimum value for a high quality factor, the diameter D might be chosen larger or smaller for achieving better temperature compensation.

In FIG. 4, a further type of cylindrical combline cavity resonator 1 is shown to which the method of the present invention can be applied. This resonator is essentially identical to the resonator shown in FIG. 1, and like parts are designated by the same reference numerals. The cavity resonator 1 shown in FIG. 4 differs from the cavity resonator shown in FIG. 1 in that its inner conductor 6 comprises two sections 9, 10 and in that a tuning screw 11 is disposed in the cover plate 5 of the resonator 1. The lower section 9 of the inner conductor 6 has a length L₁ and a diameter D₁ and the upper section 10 of the inner conductor 6 has a length L₂ and a diameter D₂. The optimization procedure is identical to the optimization described with respect to FIGS. 1 to 3. However, more degrees of freedom are available for the optimization. Thus, if desired, one can also sweep over L₁, L₂, D₁ and/or D₂. Further, the cross-sectional shape and/or the material of the two sections 9, 10 could also be used as free parameters for the purpose of the optimization procedure. The same applies to the shape, length and/or material of the tuning element 11. In general, the upper section 9 of the inner conductor 6 has the greatest influence on the capacity of the resonator 1. In case of high energy densities, the capacitive gap and the diameter of the top section 10 should preferably be suitably large.

In FIG. 5, a schematic diagram of a preferred embodiment of the method in accordance with the present invention is shown. According to this embodiment, the values for a set of construction parameters are determined by sweeping over the parameter space defined by the set of construction parameters. In step 12, the nominal resonant frequency f_{0,n} is chosen, i.e. the predetermined resonant frequency at which the resonator is intended to operate. In steps 13 and 14, the nominal or ideal operating temperature T₀ and the operating temperature range ΔT, respectively, are chosen for the resonator. In step 15, a first set of N construction parameters for use in the parameter sweep is chosen, the parameters in this set being Pᵢ (i=1, . . . , n) . Additionally, a second set of M construction parameters Cⱼ is chosen (step 16). The purpose of the second set will be described below with reference to step 19.

In step 17, a grid is created within the parameter space defined by the first set of construction parameters. The dimensions of this grid are chosen to reflect, for each parameter Pᵢ, the minimum and maximum values used in the sweep. Further, for each parameter Pi the grid spacing is chosen by balancing accuracy against calculation time. Next, the parameter sweep is performed by running through the grid (step 18). In this process, for each grid point values for the second set of construction parameters Cᵢ are calculated such that the constraint is met that f₀(Pᵢ, T₀)=f_{0,n}. This constraint takes into account that upon any change of one or more values of parameters Pᵢ, the resonant frequency f₀ likewise changes if all remaining parameters as well as the temperature are kept constant. Accordingly, the values of the parameters Cᵢ are varied such that the resonant frequency f₀ is always at its nominal value for the nominal operating temperature T₀. On this basis, the temperature induced change of resonant frequency Δf₀/ΔT is calculated for each grid point (step 20).

In step 21, the result of the sweep through the parameter grid is analyzed to find the location in the parameter space defined by values for the parameters P₁, . . . , P_{N} of the first set of construction parameters yielding the minimum value for Δf₀/ΔT. In step 22, the found minimum value of Δf₀/ΔT is examined to check whether it lies below a predetermined value reflecting the measure of temperature compensation necessary or desirable for the intended application. Only if this check is successfully passed, temperature compensation is obtained and a resonator is produced in accordance with the determined values for the parameters P₁, . . . , P_{N} and C₁, . . . , C_{M} of the first and second set of construction parameters, respectively, in step 23. If the check is not successfully passed, a new first set of construction parameters for use in the parameter sweep is chosen in step 24, wherein the number N of parameters in this set may be equal or different from the number used in the preceding first set.

This embodiment provides the advantage that all possible solutions are provided. Therefore, one can even choose a less optimum solution, e.g. to make a trade-off between the frequency drift and the quality factor of the resonator. Furthermore, the embodiments facilitates analyzing the sensitivity of any possible solution with respect to tolerances. The method according to this embodiment may result in contour plots such the plots shown in FIGS. 2 and 3.

In FIG. 6, a schematic diagram of a further preferred embodiment of the method in accordance with the present invention is shown. According to this embodiment, the values for a set of construction parameters are determined by using an arbitrary optimization algorithm capable of minimizing the value of a quantity over a parameter space under a constraint. An example for a known method is the gradient method. In FIG. 6, steps which are identical to the steps of the embodiment shown in FIG. 5 are designated by identical reference numerals.

The method of the embodiment shown in FIG. 6 starts with steps 12, 13, and 14 described above with reference to FIG. 5. In step 25, a set of N construction parameters for use as variables in the minimization algorithm is chosen, the parameters in this set being Pᵢ (i=1, . . . , n). In step 26, minimum, maximum and starting values are chosen for each parameter Pᵢ. In step 27, the minimization is performed in accordance with the selected minimization method under the constraint that f₀(Pᵢ, T₀)=f_{0,n}. This constraint has been described above with reference to FIG. 5. However, in the present embodiment no separate set of construction parameters has to be chosen to meet this constraint. Rather, the minimization method automatically accounts for the constraint by varying the set Pᵢ such that the requirement defined by it is fulfilled. The output of step 27 is a set of values for the parameters P₁. . . , P_{N} yielding a minimum value for Δf₀/ΔT. However, in this embodiments there is the danger, that the minimum automatically found by the algorithm is merely a local minimum rather than the optimum solution. In step 22, it is checked whether temperature compensation has indeed been achieved as described above with reference to FIG. 5. If this is the case, a resonator is produced in accordance with the determined values for P₁, . . . , P_{N} in step 23. Otherwise, a new set of construction parameters for use in the optimization algorithm is chosen in step 28, wherein the number N of parameters in this set may be equal or different from the number used in the preceding set.

The above calculations may in part or in their entirety advantageously be performed by means of suitable computer programs.

1. A method of determining values for a set of construction parameters of a cavity resonator comprising a housing having a base, a sidewall extending upwardly from the base and an upper cover plate, and an inner conductor having a width dimension D and extending upwardly from the base along a length L, the housing comprising a first material and the inner conductor comprising a second material different from the first material, the method comprising the steps of:
calculating the resonant frequency f₀ as a function of temperature and the set of construction parameters, and
varying the values of the set of construction parameters and repeating the calculating step to derive optimum values for the set of construction parameters from the result of the calculation yielding a minimum temperature induced change of resonant frequency f₀ in a given temperature range ΔT with respect to the set of construction parameters, characterized in that the set of construction parameters includes the width dimension D of the inner conductors.

2. The method according to claim 1, wherein the cavity resonator is a cavity resonator filter.

3. The method according to claim 1, wherein the set of construction parameters includes the length L of the inner conductor and/or the geometry of the inner conductor.

4. The method according to claim 1, wherein the set of construction parameters includes the height H of the housing, the width dimension A of the housing and/or the geometry of the housing.

5. The method according to claim 1, wherein the set of construction parameters includes the first material and/or the second material.

6. The method according to claim 1, wherein the inner conductor comprises at least two sections, each having a length Lᵢ, a width dimension Dᵢ and a geometry, and each comprising a material.

7. The method according to claim 6, wherein the set of construction parameters includes the length Lᵢ of at least one of the sections of the inner conductor, the width dimension Dᵢ of at least one of the sections of the inner conductor, the geometry of at least one of the sections of the inner conductor and/or the material of at least one of the sections of the inner conductor.

8. The method according to claim 6, wherein the inner conductor is a composite element also comprising at least a third material different from the second material.

9. The method according to claim 8, wherein the section of the inner conductor adjacent the base is formed integrally with the base.

10. The method according to claim 1, wherein the housing comprises at least two sections, each having a length Hᵢ, a width dimension Aᵢ and a geometry, and each comprising a material.

11. The method according to claim 10, wherein the set of construction parameters includes the length Hᵢ of at least one of the sections of the housing, the width dimension Aᵢ of at least one of the sections of the housing, the geometry of at least one of the sections of the housing and/or the material of at least one of the sections of the housing.

12. The method according to any of the preceding claim 1, wherein in at least a portion of the inner conductor a width dimension functionally depends on the longitudinal position along the length of the inner conductor.

13. The method according to claim 12, wherein the set of construction parameters includes the functional dependence between the width dimension of the inner conductor and the longitudinal position along the length of the inner conductor.

14. The method according to claim 1, wherein in at least a portion of the housing a width dimension functionally depends on the longitudinal position along the length of the housing.

15. The method according to claim 14, wherein the set of construction parameters includes the functional dependence between the width dimension of the housing and the longitudinal position along the length of the housing.

16. The method according to claim 1, wherein the optimum values for the set of construction parameters are derived under at least one boundary condition or constraint.

17. The method according to claim 16, wherein the method further comprises the step of calculating the quality factor as a function of temperature and the set of construction parameters, and wherein the optimum values for the set of construction parameters are derived under the boundary condition that the quality factor is larger than a predetermined value.

18. The method according to claim 1, wherein the calculation of the resonant frequency is performed using a mode matching method.

19. The method according to claim 1, wherein a tuning element is partially inserted into an aperture of the cover plate and is selectively movable to protrude into the cavity in alignment with the inner conductor.

20. The method according to claim 19, wherein the set of construction parameters includes the material of the tuning element and/or the protrusion depth of the tuning element into the cavity.

21. The method according to claim 1, wherein the inner conductor is cylindrical.

22. The method according to claim 1, wherein the housing is cylindrical.

23. A method of producing a cavity resonator comprising the steps of:
determining values for a set of construction parameters using the method of claim 1,
providing a housing in accordance with the determined values,
providing an inner conductor in accordance with the determined values,
attaching the inner conductor to the housing.
